(19) United States
(12) Patent Application Publication
(10) Pub. No.: US 2012/0107034 A1
(43) Pub. Date: May 3, 2012

(54) WRITING INSTRUMENT WITH RETRACTABLE TIP

(76) Inventor: Davide Calabrese, Torino (IT)

(21) Appl. No.: 13/380,258

(22) PCT Filed: Jun. 11, 2010
(86) PCT No.: PCT/IT2010/000263

§ 371 Date: Dec. 22, 2011

(30) Foreign Application Priority Data
Jun. 25, 2009 (IT) TO2009U000091

(51) Int. Cl. B43K 5/16; B43K 23/12; B43K 8/24

(52) U.S. Cl. 401/108; 401/99

(57) ABSTRACT

A writing instrument is described, composed of a body adapted to contain therein ink or at least one ink cartridge, connected to a delivering tip for this ink, the delivering tip sliding inside the body between a first operating position in which the delivering tip goes out of an opening and a second rest position in which the delivering tip is retracted from the opening and is contained inside the body.

The present invention refers to a writing instrument, in particular an highlighting pen, with retractable tip.

Writing instruments are known, such as pens, felt-tip pens and highlighting pens, composed of a body that contains an ink cartridge connected to the delivering tip and a removable cap suitable to cover and protect such tip, in order to avoid at the same time that ink dries when using the writing instrument.

In particular, as clearly appears from their practical use, highlighting pens are used in order to highlight some parts of a text when reading: sometimes such parts are spaced apart by several lines of text one from the other and, during the time interval dedicated to reading, the highlighting pen can remain with its tip uncovered, making the tip dry and lose its sliding flowability. Obviously, such inconvenience can be solved by covering every time the tip with its respective cap, this however creating continuous losses of time.

In order to more practically solve the above inconveniences, the art has proposed highlighting pens with a retractable tip, like those disclosed for example in U.S. Pat. No. 5,203,638, US-D-546385 and U.S. Pat. No. 6,155,733: such highlighting pens substantially exploit the rather complex retraction mechanism of ball-type pens with click-type actuating button placed on the rear part of the highlighting pen. Moreover, in such highlighting pens, the retractable tip remains anyway partially exposed to the external environment even when it is retracted, since the opening from which it goes out during use is never completely closed.

Object of the present invention is solving the above prior art problems by providing a writing instrument, in particular an highlighting pen, with retractable tip equipped with a retraction mechanism that can be easily and practically used.

Another object of the present invention is providing a writing instrument, in particular an highlighting pen, with retractable tip in which the tip is completely protected from the external environment when it is not used.

The above and other objects and advantages of the invention, as will appear from the following description, are obtained with a writing instrument, in particular an highlighting pen, with retractable tip as claimed in claim 1. Preferred embodiments and non-trivial variations of the present invention are the subject matter of the dependent claims.

The present invention will be better described by some preferred embodiments thereof, provided as a non-limiting example, with reference to the enclosed drawings, in which:

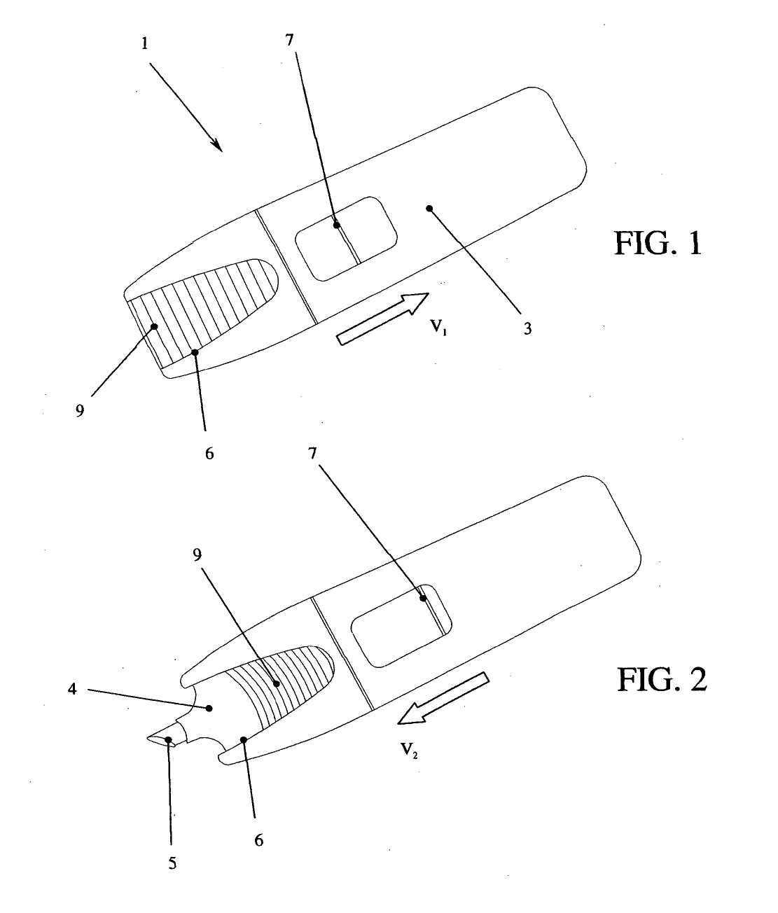

FIG. 1 shows a side perspective view of a preferred embodiment of the writing instrument with retractable tip according to the present invention in a rest position thereof; and

FIG. 2 shows a side perspective view of a preferred embodiment of the writing instrument with retractable tip of FIG. 1 in an operating position thereof.

With reference to the Figures, it is possible to note that the writing instrument with retractable tip 1 according to the present invention is composed of a body 3 adapted to contain therein directly ink or at least one ink cartridge, connected to a delivering tip 5 for such ink. The body 3 is further typically adapted to be grasped by the finger to allow using the highlighting pen 1 itself.

Advantageously, the writing instrument 1 according to the present invention further comprises at least one retractable delivering tip 5 sliding inside such body 3 along a longitudinal direction and connected to such cartridge in a substantially known way to allow delivering ink: the delivering tip 5 can then slide between a first operating position (like the one shown for example in FIG. 2) in which the delivering tip 5 goes out of a suitable opening 6 of such body 3 and a second rest position (like the one shown for example in FIG. 1), in which the delivering tip is retracted from the opening 6 and is wholly contained inside the body 3.

Sliding of such delivering tip 5 is performed by a retraction mechanism driven by driving means preferably comprising at least one sliding cursor-type button 7 arranged externally to the body 3 in order to be actuated by a finger of a user and integrally and internally connected to a carrier and sliding structure 4 for such sliding delivering tip 5: the sliding cursor-type button 7 is thereby adapted to slide along a first direction (according to what is shown, for example, by arrow V₁ in FIG. 1) and a second direction (according to what is shown, for example, by arrow V₂ in FIG. 2) in order to correspondingly slide the sliding delivering tip 5 inside the body 3 between its first position and its second position and vice versa.

In order to protect the delivering tip 5 when it is inside the body 3 in its rest position and prevent ink from drying, the writing instrument 1 according to the present invention is further equipped with at least one sliding gate 9 for protecting the opening 6, preferably made of a suitably flexible plastic material, whose sliding is also driven by the driving means, and in particular by the sliding cursor-type button 7, to which it is kinematically connected, in such a way as to wholly cover the opening 6 when the delivering tip 5 is in its rest position, and to uncover the opening 6 when the delivering tip 5 is taken to its operating position and allow the body 3 to go out through the opening 6 itself.

With reference then to the Figures, it is possible to note that the operation and use of the writing instrument 1 according to the present invention are at the same time practical, quick and efficient: therefore, starting from the rest position of FIG. 1, in which the sliding gate 9 is closed and protects the opening 6, by sliding the sliding cursor-type button 7 along the first direction V₁, the sliding gate 9 slides inside the body 3 to uncover the opening 6 and, at the same time, the delivering tip 5 also slides inside the body 3 to go out of the opening 6 and to reach its operating position of FIG. 2. By performing the contrary movement, thereby starting from the operating position of FIG. 2, in which the sliding gate 9 is open, by sliding the sliding cursor-type button 7 along the second direction V₂, the sliding gate 9 slides inside the body 3 in order to cover the opening 6, and simultaneously the delivering tip also slides inside the body 3 to be retracted from the opening 6 and go again inside the body 3 in its rest position of FIG. 1, preventing it from drying.

Obviously, the writing instrument with retractable tip 1 according to the present invention can be a pen, a felt-tip pen or an highlighting pen, or any other instrument compatible with the features of what has been described above, and consequently the delivering tip 5 will be suitably made depending on the type of ink to be delivered. In particular, FIGS. 1 and 2 show a preferred embodiment of the instrument 1 according to the present invention in the shape of an highlighting pen. In this case, as can be noted from what is described above, the movement suitable to take the delivering tip 5 between its operating position and its rest position is quick and practical, completely compatible with traditional times of use of known highlighting pens, simultaneously allowing to prevent ink from drying during the pauses of use of the highlighting pen 1 according to the present invention.

1. A writing instrument comprising a body adapted to contain therein ink or at least one ink cartridge, connected to a delivering tip for the ink, wherein the delivering tip is sliding inside the body between a first operating position in which the delivering tip goes out of an opening of the body and a second rest position in which the delivering tip is retracted from the opening and is contained inside the body.

2. The writing instrument of claim 1, wherein the delivering tip slides a retraction mechanism driven by driving means.

3. The writing instrument of claim 2, wherein the driving means comprise at least one sliding cursor-type button arranged externally to the body, integrally and internally connected to the sliding delivering tip, the sliding cursor-type button being adapted to slide along a first direction and a second direction in order to reversibly slide the sliding delivering tip inside the body between the first position and the second position.

4. The writing instrument of claim 2, wherein the writing instrument comprises at least one sliding gate for protecting the opening, the sliding gate being slid by the driving means in order to cover the opening when the delivering tip is in the rest position, and to uncover the opening when the delivering tip is in the operating position and in order to allow the delivering tip to go out of the body through the opening.

5. The writing instrument of claim 1, wherein the writing instrument is a pen.

6. The writing instrument of claim 1, wherein the writing instrument is a felt-tip pen.

7. The writing instrument of claim 1, wherein the writing instrument is a highlighting pen.
